(19) United States
(12) Patent Application Publication
(10) Pub. No.: US 2008/0108327 A1
(43) Pub. Date: May 8, 2008

(54) Method and communication device for transmitting message

(75) Inventors: Ting-Chung Hsu, Taichung City (TW); Yi-Chia Chiang, Taipei City (TW); Hai-Ti Hsu, Taipei City (TW)

Correspondence Address: REED SMITH LLP, Suite 1400, 3110 Fairview Park Drive, Falls Church, VA, 22042, US

(73) Assignee: BenQ Corporation

(21) Appl. No.: 11/889,027

(22) Filed: Aug. 8, 2007

(30) Foreign Application Priority Data
Nov. 8, 2006 (TW) 95141317

(51) Int. Cl. H04Q 7/22

(52) U.S. Cl. 455/412.1; 455/466

(57) ABSTRACT

A method and a communication device for transmitting a data message to a remote device are provided. The communication device includes a storage unit, a message editing module, and a communication module. The storage unit is for storing a plurality of multimedia data. The message editing module is for editing data message, and the data message includes an envelope content, a body content, and an identifying tag, wherein the envelope content is selected from the plurality of multimedia data. The communication module is for transmitting the data message to the remote device. According to the identifying tag, the remote device processes the envelope content directly when receiving the data message.

### CROSS REFERENCE TO RELATED APPLICATIONS

This application claims the right of priority based on Taiwan Patent Application No. 095141317 entitled “Method and Communication Device for Transmitting Message”, filed on Nov. 8, 2006.

### TECHNICAL FIELD

The present invention relates to a method and a communication device for transmitting a message, and more particularly to a method and a communication device for enabling a user of a transmitting communication device to edit an envelope content of the message.

### BACKGROUND OF THE INVENTION

For the recent years, as the technology of mobile communication develops and propagates, the mobile phones or other mobile communication devices have been indispensable to people. And it is more and more common to communicate or convey information by transmitting short messages. Presently, the short message service (SMS) for transmitting text messages is one of the most familiar mobile communication services. Besides, the enhanced message service (EMS) or the multimedia message service (MMS) for transmitting multimedia messages is more and more popular among the consumers.

For transmitting a message, the message is edited by a user of a transmitting mobile unit, and then transmitted to a receiving mobile unit. When the receiving mobile unit receives the message, the user of the receiving mobile unit would be notified of an incoming message by a message window automatically popped up on a screen without taking any action. For the present mobile unit, the message window of the incoming message can only display the identity or the associated phone number or a preset image of the transmitting mobile unit. However, if the user of the receiving mobile unit wants to read the content of the message, he needs to input an external instruction from the interface of the mobile phone for enabling the mobile unit to display the content of the message. Therefore, unlike the traditional postal mail, the user of the transmitting mobile unit is unable to design an envelope with his personal style, and therefore the user of the receiving mobile unit can feel no emotional connection with the user of the transmitting mobile unit as receiving the message.

As the technology advances, the mobile phones have been equipped with more and more functions and provide people with more convenience, but at the same time, the meaning and fun represented by the traditional service have been lost gradually over time. In the function-oriented environment, it is beneficial to give attention to both tradition and modernity for making the mobile phones more valuable.

### SUMMARY OF THE INVENTION

In light of the problems of the prior art, the present invention provides a method and a communication device for transmitting a message, wherein a user of a transmitting mobile unit can add a specific identifying tag to the message, and a user of a receiving mobile unit can feel the meanings brought by the message via the identifying tag.

According to one aspect of the present invention, a communication device for transmitting a data message to a remote device is provided. The communication device of the present invention includes a storage unit, a message editing module, and a communication module. The storage unit is for storing a plurality of multimedia data. The message editing module is for editing the data message, and the data message includes an envelope content, a body content, and an identifying tag. The envelope content can be selected from the plurality of multimedia data stored in the storage unit. The communication module is for transmitting the data message to the remote device. According to the identifying tag, the remote device processes the envelope content directly when receiving the data message.

According to another aspect of the present invention, a communication device for communicating with a remote device is provided. The communication device of the present invention includes a storage unit, a message editing module, and a communication module. The storage unit is for storing a plurality of multimedia data. The message editing module is for setting an identifying tag in a data message, and the identifying tag corresponds to a predetermined part of the data message, wherein the predetermined part is selected from the plurality of multimedia data. The communication module is for transmitting the data message to the remote device. According to the identifying tag, the remote device processes the predetermined part directly when receiving the data message.

According to yet another aspect of the present invention, a method for transmitting a data message from a transmitting device to a receiving device is provided. The method of the present invention includes the following steps: storing a plurality of multimedia data in the transmitting device; editing an envelope content and a body content, the envelope content being selected from the plurality of multimedia data; combining the envelope content, the body content and an identifying tag as the data message; transmitting the data message; and the receiving device receiving the data message and processing the envelope content directly according to the identify tag.

Other aspects of the present invention would be stated and easily understood through the following description or the embodiments of the present invention. The aspects of the present invention would be appreciated and implemented by the elements and their combinations pointed out in the appended claims. It should be understood that the above summary of the invention and the following detailed description are only illustrative but not to limit the present invention.

### BRIEF DESCRIPTION OF THE DRAWINGS

FIG. 1 illustrates a short message service architecture according to the present invention;

FIG. 2 is a flow chart showing a process for setting a data message by a transmitting communication device;

FIG. 3 is a schematic diagram showing two envelope contents generated based on the EMS format and the MMS format respectively according to a preferred embodiment of the present invention;

FIGS. 4A and 4B are schematic diagrams illustrating two processes for retrieving an envelope content of a data message when the data message is received by a receiving communication device under SMS format and MMS format respectively; and

FIG. 5 is a flow chart showing a method of transmitting message according to the present invention.

### DETAILED DESCRIPTION OF THE PREFERRED EMBODIMENTS

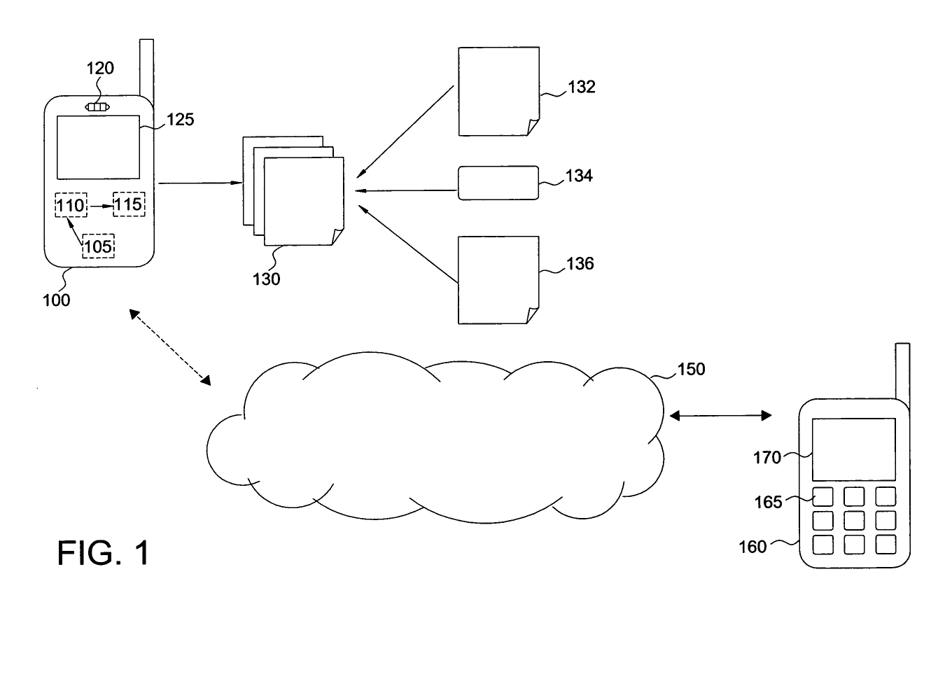

A method and a device for personalizing message content are disclosed in the present invention. To make the disclosure of the present invention more detailed and complete, references are made to the following description in conjunction with FIGS. 1-5. Nevertheless, the apparatus, elements and steps of the method described in the following embodiments are only for illustration but not to limit the scope of the present invention.

FIG. 1 illustrates a short message service architecture according to the present invention, which includes a transmitting communication device 100 and a receiving communication device 160 communicating with each other over a network 150. For example, the transmitting communication device 100 and the receiving communication device 160 may be common mobile phones, and the network 150 may be a mobile communication network. For another example, the transmitting communication device 100 and the receiving communication device 160 may be Internet phones, and the network 150 may be an internet-based network. The transmitting communication device 100 includes a storage unit 105, a message editing module 110, and a communication module 115. In addition, the transmitting communication device 100 may further include a screen 125, a button (not shown), other known Man/Machine Interface, etc.

The storage unit 105 is for storing a plurality of multimedia data, which may include, for example, audio files, image files, animation files, or video files. The transmitting communication device 100 may further include an image capture device 120 for capturing an image, such as an image of a user of the transmitting communication device 100, wherein the image captured by the image capture device 120 can be stored in the storage unit 105 as one of the plurality of multimedia data. It is noted that the storage unit 105 can be also for storing various data, such as telephone book data.

The message editing module 110 is for editing a data message 130 that includes an envelope content 132, a body content 136, and an identifying tag 134. The body content 136 is main content of the message edited by the user of the transmitting communication device 100, and can be in text-only format or multimedia format, such as the Short Message Service (SMS) format, Enhanced Message Service (EMS) format, Multimedia Messaging Service (MMS) format, or other known format. The envelope content 132 is also edited by the user of the transmitting communication device 100, which may include, for example, image and/or audio selected from the multimedia data stored in the storage unit 105. The identifying tag 134 is for identifying the envelope content 132, and may include, for example, a start tag, an end tag, or the size information of the envelope content 132, in which the receiving communication device 160 can retrieve the content of the envelop content 132 from the data message 130 according to the identifying tag 134 and then make further process.

When the user of the transmitting communication device 100 finishes the edition of the data message 130, the data message 130 can be transmitted to the receiving communication device 160 via the network 150 by the communication module 115. The receiving communication device 160 may include a screen 170, a button 165, and/or other known Man/Machine Interfaces, such as a loudspeaker, an earphone, an antenna, etc. When the receiving communication device 160 receives the data message 130, a message window will pop up on the screen 170 to notify the user of the receiving mobile device 160 of an incoming message. Besides, by the identifying tag 134, the receiving communication device 160 can retrieve the envelope content 132 from the data message 130 and perform the step of directly showing or displaying the image and/or the audio included within the envelope content 132, in which the image and audio act as background picture and background music of the message window. From the step of receiving the data message 130 by the receiving communication device 160 to the step of showing the image and/or audio, it doesn't require the user of the receiving communication device 160 to do anything. Stated in another way, according to the present invention, the user of the receiving communication device 160 can directly perceive the personal-style envelope content 132 edited by the transmitting communication device 100 without operating the receiving communication device 160. In one embodiment, the user of the transmitting communication device 100 can use his picture or voice as the envelope content 132, so that the user of the receiving communication device 160 can easily identify the origin of the data message 130 while receiving it. The envelope content 132 and the identifying tag 134 can be defined in the format of SMS, EMS, or MMS. Therefore, no matter the receiving communication device 160 can support the display of the envelope content 132 or not, the envelope content 132 can be read and shown by a standard way.

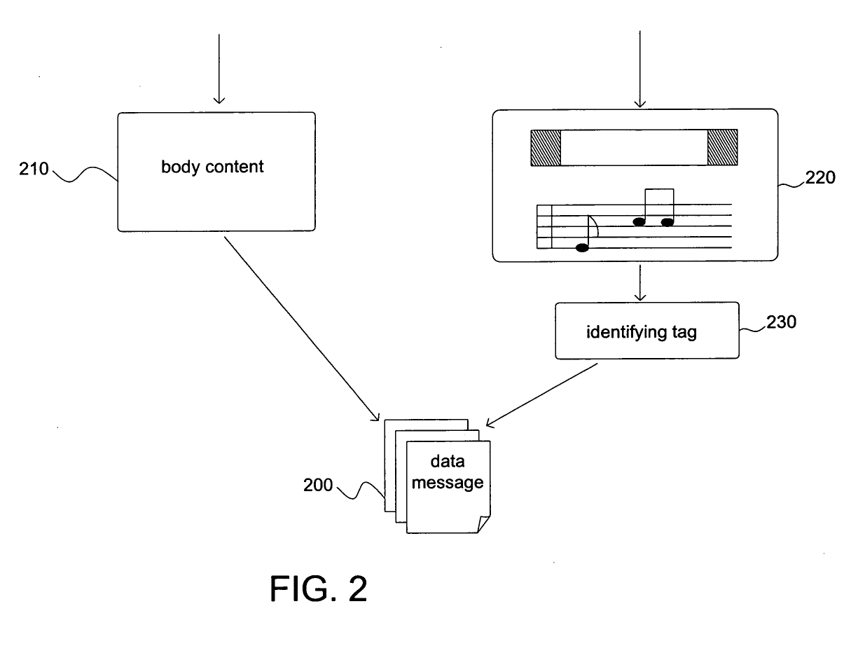

FIG. 2 is a flow chart showing a process for setting a data message 200 by a transmitting communication device. The data message 200 includes a body content 210, an envelope content 220, and an identifying tag 230. The body content 210 can be edited to contain text, image, and/or audio, wherein the way to edit the body content 210 is same as the prior art, so the detail description thereof is omitted. The envelope content 220 can also be edited by the user of the transmitting communication device, which can be selected from various multimedia files, such as audio files, image files, animation files, or video files. After being edited, the envelope content 220 is identified by the identifying tag 230 and combined with the body content 210 to form the data message 200. Next, the data message 200 can be transmitted in a standard format over a network by the transmitting communication device.

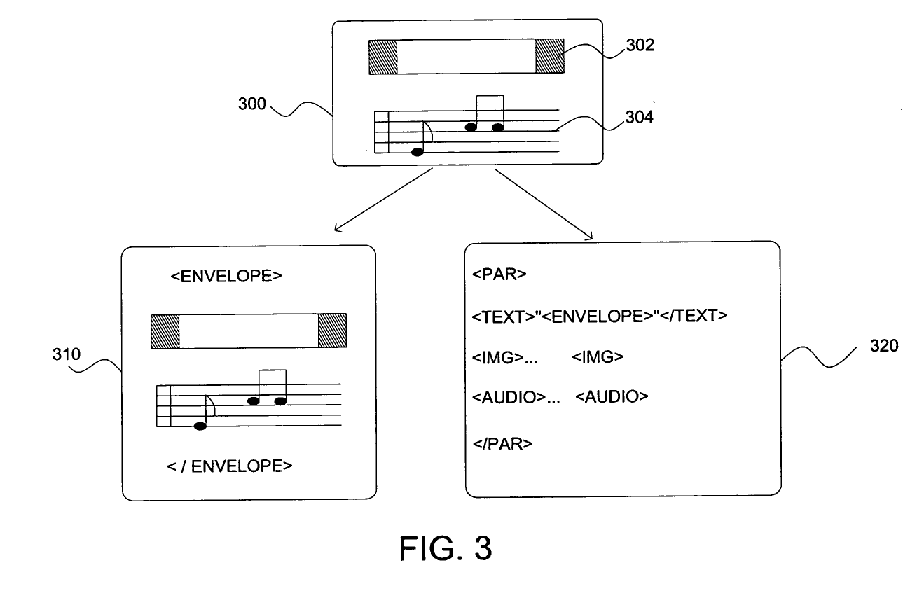

FIG. 3 is a schematic diagram showing two envelope contents generated based on the EMS format and the MMS format respectively according to a preferred embodiment of the present invention. In this embodiment, the definition of the envelope content conforms to the content body format of EMS and MMS defined in W3C SMIL 2.0 and 3GPP TS 03.40 for enabling all communication devices to read the envelope content in a standard way, even though some communication device do not support the display of the envelope content.

As shown in FIG. 3, image 302, audio 304, and/or other files are selected from the multimedia files 300 to act as the envelope content, and then the envelope content are identified in EMS format or MMS format. When using the EMS format, an identifying tag including a start tag “<ENVELOPE>” and an end tag “</ENVELOPE>” is added after editing an envelope content. The edited envelope content is located between the start tag “<ENVELOPE>” and the end tag “</ENVELOPE>” to form an EMS envelope 310. It is noted that the identifying tag can be named by a designer of the communication device, rather than being limited to “ENVELOPE”. On the other hand, when using the MMS format, an identifying text file, such as <TEXT> “<ENVELOPE>” </TEXT>, is added after editing an envelope content as the identifying tag of the envelope content. Similarly, the name of the identifying tag is not limited to “ENVELOPE”. <PAR>, </PAR>, <TEXT>, </TEXT>, <IMG>, </IMG>, <AUDIO>, and </AUDIO> are standard tags under MMS format, wherein <IMG> and </IMG> are for defining the selected image, <AUDIO> and </AUDIO> are for defining the selected audio, and <PAR> and </PAR> are for defining a page under MMS format. Adding the identifying text file <TEXT> “<ENVELOPE>” </TEXT> in front of the edited envelope content can form a MMS envelope 320. The identifying tags shown in FIG. 3 can be defined and programmed in advance by the designer of the communication device, so that the user only needs to input an envelope content and a body content, and the communication device will add an identifying tag automatically according to the content inputted by the user.

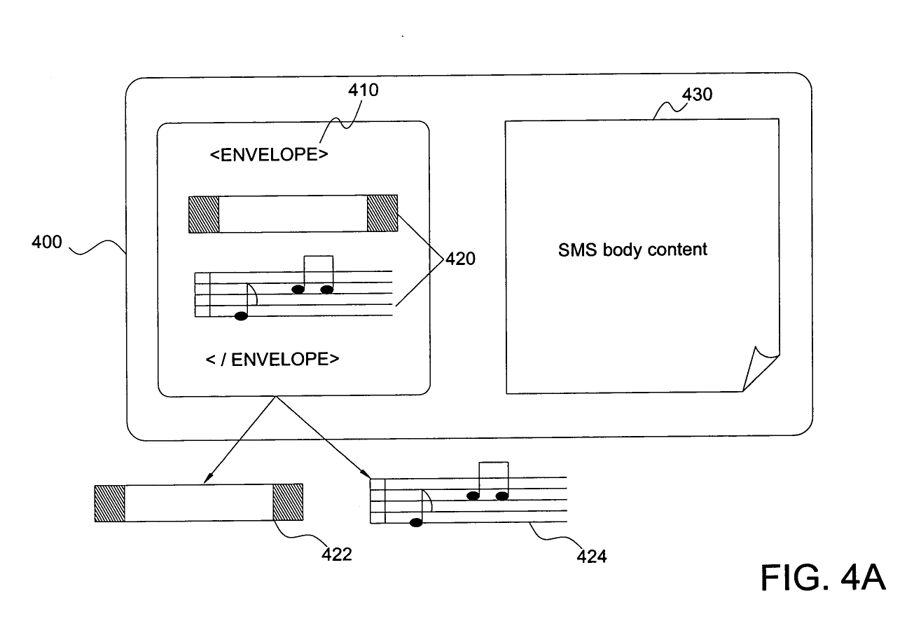

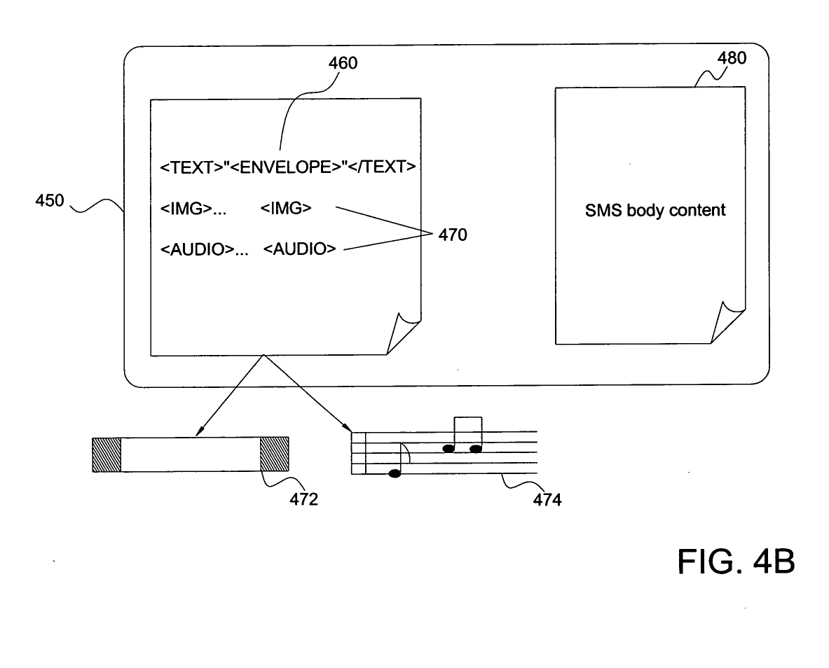

FIGS. 4A and 4B are schematic diagrams illustrating two processes for retrieving an envelope content of a data message when the data message is received by a receiving communication device under SMS format and MMS format respectively. As shown in FIG. 4A, under the EMS format, the receiving communication device receives a data message 400 including an identifying tag 410, envelope content 420, and body content 430, and then according to the identifying tag <ENVELOPE> and </ENVELOPE> 410, directly retrieves and outputs image 422 and audio 424 included within the envelope content 420. As shown in FIG. 4B, under the MMS format, the receiving communication device receives a data message 450 including an identifying tag 460, envelope content 470, and body content 480. And then according to the identifying tag <TEXT> “<ENVELOPE>” </TEXT> 460, the content in a page corresponding to the identifying tag is retrieved as the envelope content of the received message and the image 472 and audio 474 therein are outputted directly.

The present invention is implemented in the existing architecture without reconstructing a new computer language. For example, in the present invention, the identifying tag for identifying envelope content can be defined by the EMS format or the MMS format. For both the EMS format and the MMS format, <ENVELOPE> is a part of the message content, and the communication device can determine that the image and audio following the <ENVELOPE> are a part of the envelope content as long as retrieving the term <ENVELOPE>. If the communication device doesn't support the display of the envelope content, the <ENVELOPE> will be treated as text data within the body content. In other words, the envelope content will be displayed according to the identifying tag if the receiving communication device can support, and the message reception will not be influenced even if the receiving communication device doesn't support.

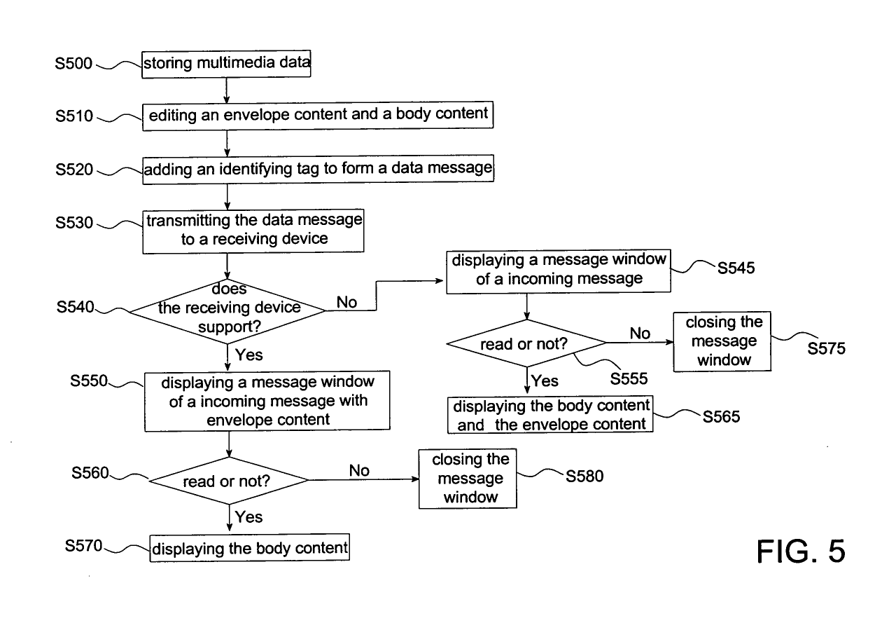

FIG. 5 is a flow chart showing a method of transmitting message according to the present invention. The method can be applied to a transmitting device and a receiving device, wherein the receiving device can receive the message from the transmitting device. First, in step S500, a plurality of multimedia data are stored in the transmitting device, which can include audio file, image file, animation file, or video file. In addition, the transmitting device can include an image capture device for capturing an image of a user of the transmitting device, and the image is stored in the transmitting device as one of the plurality of multimedia data. Next, in step S510, an envelope content and a body content are edited, wherein the envelope content is selected from one of the plurality of multimedia data or a combination of the plurality of multimedia data. In another embodiment, the envelope content can be the any image captured by the image capture device. The format of the body content may be, for example but not limit to, the SMS format, the EMS format, or the MMS format.

In the step S520, an identifying tag is added to enable the receiving device to identify the envelope content, wherein the envelope content, the body content, and the identifying tag are combined as a data message. Next, in step S530, the data message is transmitted in a standard format over the network, such as mobile communication network or Internet, by the transmitting device. In step S540, the receiving device determines if it supports the display of the envelope content when receiving the data message containing the envelope content. If not, the procedure proceeds to step S545, the receiving device displays a message window with a predetermined background. Next, in step S555, the user of the receiving device decides whether to read the body content of the data message, and if not, the procedure proceeds to step S575, the message window is closed. If the user of the receiving device decides to read the body content of the data message, the procedure proceeds to step S565, and an external instruction is inputted by the user to enable the receiving device to display both the body content and the envelope content.

If it is determined that the receiving device supports the display of the envelope content in the step S540, the procedure proceeds to step S550. The receiving device identifies the envelope content and then retrieves its content (such as image and/or audio), and the retrieved content is set as the background picture and background audio of the message window. The receiving device can notify the use of the incoming message by the message window with the envelope content. Next, in step S560, the user of the receiving device decides whether to read the body content of the data message, and if not, the procedure proceeds to step S580, the message window is closed. If the user of the receiving device decides to read the body content of the data message, the procedure proceeds to step S570, and an external instruction is inputted by the user to enable the receiving device to display the body content.

The above description is only for the preferred embodiments of the present invention but not to limit the scope of the invention. Any other equivalent changes or modifications without departing from the spirit disclosed by the present invention should be included in the appended claims.

We claim:

1. A communication device for transmitting a data message to a remote device, the communication device comprising:
a storage unit for storing a plurality of multimedia data;
a message editing module for editing the data message, the data message comprising an envelope content, a body content, and an identifying tag, wherein the envelope content is selected from the plurality of multimedia data; and
a communication module for transmitting the data message to the remote device;
wherein the remote device processes the envelope content directly according to the identifying tag when receiving the data message.

2. The communication device according to claim 1, wherein the remote device outputs multimedia data corresponding to the envelope content directly after receiving the data message and before receiving any external input instruction of the communication device.

3. The communication device according to claim 2, wherein the remote device processes the body content when receiving an external input instruction.

4. The communication device according to claim 1, wherein the envelope content is associated with a user of the communication device for enabling a user of the remote device to identify.

5. The communication device according to claim 4, further comprising:
an image capture device for capturing an image of the user of the communication device, the image being stored in the storage unit as one of the plurality of multimedia data;
wherein the message editing module selects the image as the envelope content.

6. The communication device according to claim 1, wherein the body content is defined according to a Short Message Service (SMS) format or a Multimedia Message Service (MMS) format.

7. The communication device according to claim 1, wherein the plurality of multimedia data are audio files, image files, animation files, or video files.

8. The communication device according to claim 1, wherein the envelope content is selected from one of the plurality of multimedia data or a combination of the plurality of multimedia data.

9. The communication device according to claim 1, wherein the identifying tag comprises a start tag and an end tag, and the envelope content is located between the start tag and the end tag.

10. A communication device for communicating with a remote device, the communication device comprising:
a storage unit for storing a plurality of multimedia data;
a message editing module for setting an identifying tag in a data message, the identifying tag corresponding to a predetermined part of the data message, the predetermined part being selected from the plurality of multimedia data; and
a communication module for transmitting the data message to the remote device;
wherein the remote device processes the predetermined part directly according to the identifying tag.

11. The communication device according to claim 10, wherein the remote device outputs multimedia data corresponding to the predetermined part directly after receiving the data message and before receiving any external input instruction of the communication device.

12. The communication device according to claim 11, wherein the data message comprises a body content and the predetermined part corresponding to the identifying tag, and the remote device processes the body content when receiving an external input instruction.

13. The communication device according to claim 10, wherein the predetermined part is associated with a user of the communication device for enabling a user of the remote device to identify.

14. The communication device according to claim 13, further comprising:
an image capture device for capturing an image of the user of the communication device, the image being stored in the storage unit;
wherein the message editing module selects the image as the predetermined part.

15. The communication device according to claim 10, wherein the identifying tag comprises a start tag and an end tag, and the predetermined part is located between the start tag and the end tag.

16. The communication device according to claim 10, wherein the communication module transmits the data message to the remote device via Internet.

17. A method for transmitting a data message from a transmitting device to a receiving device, the method comprising:
storing a plurality of multimedia data in the transmitting device;
editing an envelope content and a body content, the envelope content being selected from the plurality of multimedia data;
combining the envelope content, the body content and an identifying tag as the data message;
transmitting the data message; and
the receiving device receiving the data message and processing the envelope content directly according to the identify tag.

18. The method according to claim 17, further comprising:
the receiving device outputting multimedia data corresponding to the envelope content directly after receiving the data message and before receiving any one of external input instructions.

19. The method according to claim 18, further comprising:
the receiving device processing the body content when receiving an external input instruction.

20. The method according to claim 17, wherein the transmitting device comprises an image capture device, the method further comprising:
capturing an image of a user of the transmitting device; and
storing the image in the transmitting device as one of the plurality of multimedia data;
wherein the step of editing the data message is to select the image as the envelope content.
